(19) United States
(12) Patent Application Publication
(10) Pub. No.: US 2015/0336135 A1
(43) Pub. Date: Nov. 26, 2015

(54) SYSTEMS AND METHODS FOR SORTING SEEDS

(71) Applicants: Steven J. CORAK, (US); William Lee TOMLINSON, (US); PIONEER HI-BRED INTERNATIONAL, INC., Johnston, IA (US)

(72) Inventors: STEVEN J. CORAK, RALEIGH, NC (US); WILLIAM LEE TOMLINSON, Ankeny, IA (US)

(73) Assignee: PIONEER HI BRED INTERNATIONAL INC, Johnston, IA (US)

(21) Appl. No.: 14/759,076

(22) PCT Filed: Jan. 6, 2014
(86) PCT No.: PCT/US14/10366

§ 371 Date: Jul. 2, 2015

Related U.S. Application Data
(60) Provisional application No. 61/784,209, filed on Mar. 14, 2013.
(60) Provisional application No. 61/750,208, filed on Jan. 8, 2013.

(51) Int. Cl. B07C 5/342; B07C 5/36

(52) U.S. Cl. CPC B07C 5/3425; B07C 5/363; B07C 5/367

(57) ABSTRACT

A system and method are provided for separating seed or grain based on optical differences in the starch composition. A method for separating seed or grain based on optical differences in the starch composition includes receiving a seed group comprising a plurality of seeds. The method further includes illuminating each seed of the seed group from an illumination source disposed behind the seed such that the seed is back-illuminated. The method further includes sorting each seed of the seed group based on the differences in the starch composition. In some cases, the method includes sorting each seed by separating the seed group into the following groups: waxy seeds and non-waxy seeds.

### FIELD

Various embodiments of the disclosure relate generally to systems, methods, and apparatuses useful for seed sorting. More specifically, embodiments of the disclosure provide systems, methods, and apparatuses for separating seed or grain based on optical differences in the starch composition.

### BACKGROUND

Starch from maize (e.g., corn) has a variety of uses depending on its composition and quality. These applications include for example, use of maize starch to improve uniformity, stability, and texture in a variety of food products. Indeed, there is a considerable demand for certain types of maize starch.

Maize seed may, in some cases, be produced and grouped together, often times mixing seeds with certain desirable starch compositions and qualities. As such, there is a need for a fast and efficient system and method for sorting seeds based on their starch composition.

### BRIEF DESCRIPTION OF THE DRAWINGS

Having thus described the disclosure in general terms, reference will now be made to the accompanying drawings, which are not necessarily drawn to scale, and wherein:

FIG. 1 shows an example seed sorter;

FIG. 2 illustrates an example system for separating seed or grain based on optical differences in the starch composition, in accordance with example embodiments described herein;

FIG. 3 shows an example seed group of waxy and non-waxy seeds that has been sorted by an example system for separating seed or grain based on optical differences in the starch composition (such as the system illustrated in FIG. 2), in accordance with example embodiments described herein; and

FIG. 4 illustrates a flowchart of an example method for separating seed or grain based on optical differences in the starch composition, in accordance with example embodiments described herein.

### DETAILED DESCRIPTION

The disclosure now will be described more fully hereinafter with reference to the accompanying drawings, in which some, but not all embodiments are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout.

Maize varieties differ in their starch composition. For example, normal (e.g., dent, non-waxy) maize hybrids contain both amylopectin and amylose as the primary components of starch. Hybrid seed results from the deliberate crossing of two different inbred parent seed varieties. Waxy maize hybrids contain amylopectin as the predominant starch material. Amylopectin is a soluble polysaccharide and highly branched polymer of glucose found in plants. It is one of the two components of starch, the other is amylose. Amylose is a linear polymer made up of D-glucose units.

Certain properties of the amylopectin or waxy cornstarch make the waxy starch suitable for industrial uses. For example, the waxy starch is relatively easy to gelatinize such that it produces a clear viscous paste with a sticky or tacky surface, often resembling the starch produced from potato or tapioca starch (tuber starches). Amylopectin starch also has a lower tendency to retrogradate and, thus, it is has a more stable viscosity. These different properties compared to normal dent corn starch (which also contains amylose) are utilized mainly in a variety of applications including food products.

Grain produced by waxy maize hybrids is used for a variety of needs, including preparation of industrial starch. Producing waxy maize starch for industrial-scale use requires special considerations compared to the standard dent maize. The waxy gene is recessive, which requires that waxy maize fields be isolated from any nearby dent (e.g., non-waxy) maize fields by a few hundred meters to prevent cross-pollination. In some cases, volunteer dent maize plants from the previous year's cultivation may also contaminate waxy maize production. Generally, a small number of dent maize volunteers in a waxy field may be enough to contaminate the entire waxy field, resulting in waxy grains mixed with dent grains.

Such a mixture of non-waxy grains in a waxy production site may cause quality control problems for the grower. Compared to the normal dent maize, waxy hybrids are usually produced under contract for starch (wet milling). Indeed, grain produced by waxy hybrids commands a premium. Some of this premium is given to compensate for the extra costs incurred from the lower yield and the extra handling needed for quality control to ensure the proper starch composition of the grain. Often in the process of producing grain from waxy hybrids, it becomes advantageous to isolate waxy seeds or grains from non-waxy seeds or grains. Therefore, there exists a cost-effective and high-throughput need to ensure quality production and sorting of waxy maize seeds and grains to remove any non-waxy contaminants. As used herein, the terms “seed,” “grain,” and “kernel” may be used interchangeably for some example embodiments. It should also be noted that the seeds or grain referred to herein may include, but need not be limited to, transgenic, non-transgenic, inbred, hybrid, and/or a mix of thereof.

As discussed herein, waxy maize hybrids contain only amylopectin in the kernel endosperm whereas normal dent (e.g., non-waxy) hybrids contain a mixture of amylopectin and amylose starch. The commercial hybrid seed product is preferably relatively pure with respect to the waxy trait in order to insure that the producer's crop will not be rejected by the grain processors. Consequently, the parent seed lines that are used to generate the hybrid seed are relatively pure (e.g., 99.95% waxy on a kernel count basis) to be considered acceptable. It is not unusual that waxy inbred batches may have to be discarded due to contamination by non-waxy kernels.

Prior to the disclosure provided herein, rapid removal of non-waxy maize contaminant kernels from a batch of waxy parent seed based on optical properties was not available. Instead, for example, to determine the starch content in seeds, an iodine reaction was used. When seed are crushed, the amylose in non-waxy maize endosperm tissue exhibits a tendency to turn dark colored when treated with iodine, but amylopectin in the waxy seed does not. This staining property, however, does not lend itself useful because the separated seeds must be maintained in a viable condition.

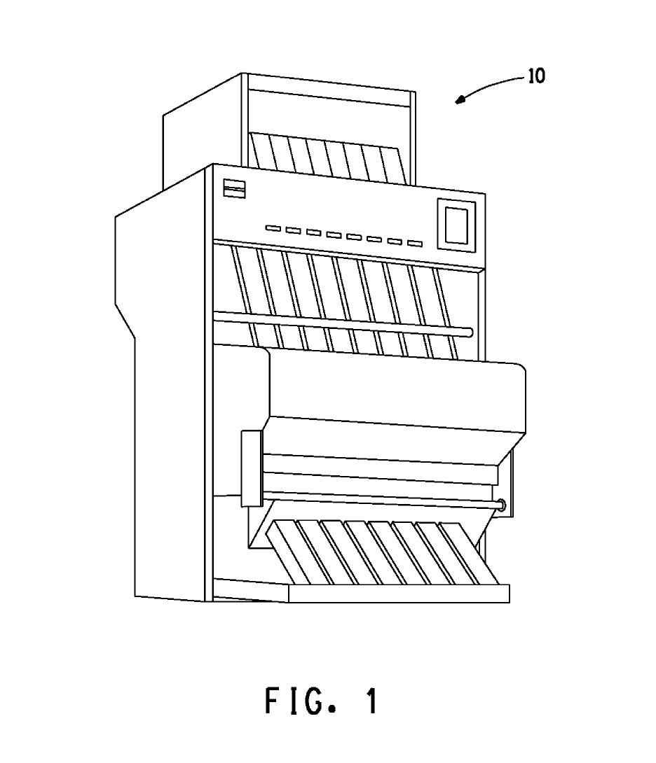

A commercially available seed sorter, such as the seed sorter 10 shown in FIG. 1, may be used to differentiate and separate seeds using high-throughput color sorting. Such sorting machines may use one or more optical sensors to differentiate seeds and contaminants based on reflected wavelength in the visible light spectrum. In bichromatic sorters, a combination of filters, such as red/green and red/blue may be used for sorting. In some cases, optical sorting machines use optical sensors that include multiple photodetectors, such as a charged-couple device and photodiode arrays. These sorting machines also usually include one or more ejector mechanisms positioned after the sensor. The ejector mechanism includes multiple air nozzles associated with one or more valves triggered by an electrical signal that is synchronized with the sensor function. When a seed having or not-having a pre-defined selection criteria is detected, an electrical signal is generated to trigger the valve of the nozzle as the selected seed passes the corresponding ejector. The blast of air removes selected seed from the flow of the remaining seed.

For example, in some cases, seed sorters are capable of removing contaminants such as fragments of the shell and hull, stones, glass, wood pieces, chipped seeds, discolored and damaged seeds, etc. Additionally, some seed sorters combine the use of conventional visible sorting and infrared sorting technology.

Embodiments of the present disclosure provide for efficient and rapid sorting of seeds based on their starch composition. This sorting is non-destructive and is based on optical properties of the sorted seeds and also does not require any special treatment or seed coating prior to sorting.

It is known that the endosperm of waxy maize kernels appears relatively opaque when back-lit by an illumination source. In contrast, the endosperm of non-waxy maize kernels appears relatively translucent when back-lit by an illumination source. Some embodiments attempt to exploit this optical difference to facilitate separation of waxy and non-waxy seeds, and thereby facilitate removal of the contaminating kernels in a high-throughput manner.

As noted above, in some embodiments, differential interaction of amylose versus amylopectin with an external illumination source may be used to facilitate high speed removal of the non-waxy contaminants. For example, in some embodiments, a color seed sorter (e.g., the seed sorter 10 shown in FIG. 1) may be configured with an optical device set up to achieve about 100 percent removal of all non-waxy contaminants after two passes through the seed sorter. In such a manner, the methods and systems disclosed herein enable the use of, for example, parent seed batches that were previously considered unacceptable for failing to have met purity specifications. Moreover, the methods and systems disclosed herein may also be applicable for use on commercially harvested waxy maize products to insure that they meet the purity requirements of end-use markets.

In some embodiments, the seeds from a bulk sample of waxy seeds (e.g., parent maize seeds or grain at a commercial elevator) may be evaluated for the presence or absence non-waxy maize kernels. In various embodiments, this evaluation step may include determining whether one or more non-waxy maize kernels are present or absent in a group of seeds. In particular, the evaluation step may include illuminating the seeds from the bulk sample at a certain wavelength and energy/intensity and then automatically determining whether non-waxy contaminating kernels are present. The certain wavelength used to illuminate the seeds may, in some cases, have a wavelength substantially within the visible photonic spectrum (i.e., a wavelength ranging from substantially about 500 nm to substantially about 580 nm). In some embodiments, a portable/handheld light spectrum scanner may be used.

In some embodiments, a seed sorter may be used to separate non-waxy kernels from a batch of seeds. Some example evaluation devices include, but are not limited to, commercially available optical seed sorters, such as a ScanMaster DE, a bichromatic visible, infra-red high capacity sorter manufactured by Satake-USA, Inc. (Stafford, Tex.). Although in normal usage, seed sorters may be used to evaluate and sort out contaminants such as rocks, glass, soil, damaged food items, mold, and other foreign material from a bulk sample of food items, some example embodiments of the present disclosure modify the seed sorter to evaluate and sort seeds based on optical differences exhibited by waxy and non-waxy maize kernels, such as based on the level of opacity of each seed. [Since opacity may be considered a condition of lacking transparency or translucence, it should be understood that in some embodiments the present invention evaluates and sorts seeds based on optical differences exhibited by waxy and non-waxy maize kernels based on the level of opacity of each seed, while in other embodiments the present invention may evaluate and sort seeds based on optical differences exhibited by waxy and non-waxy kernels based on the level of translucency.]

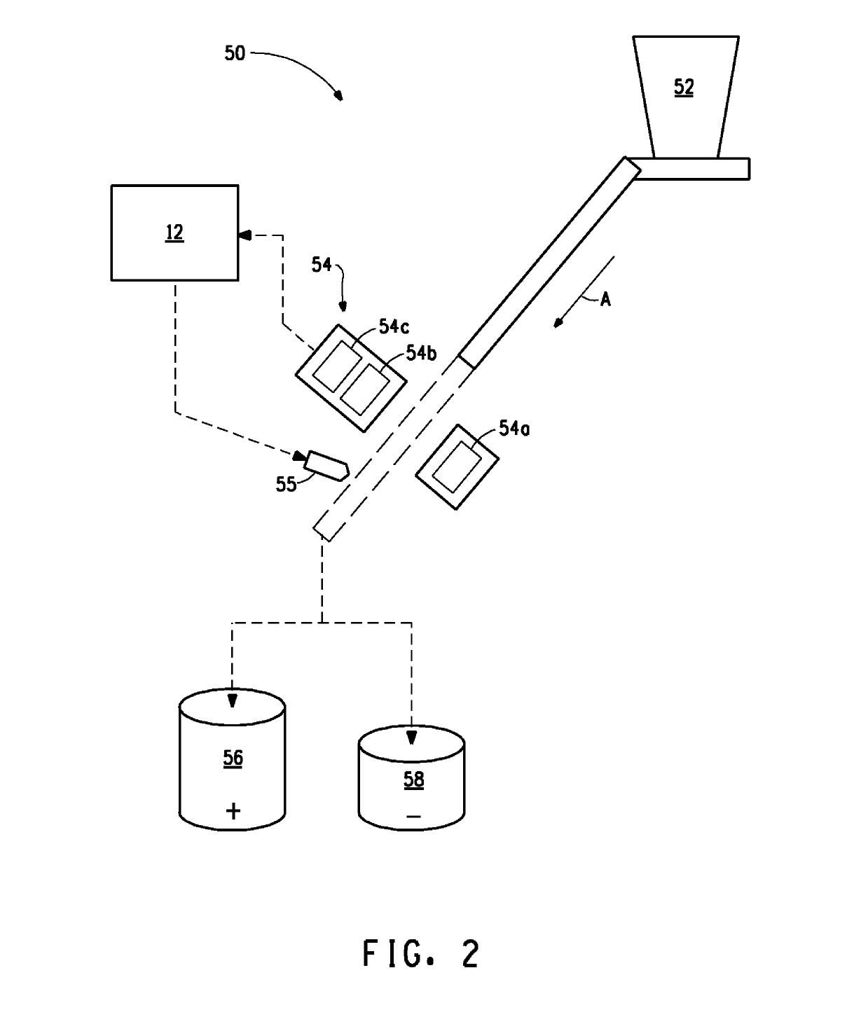

FIG. 2 shows a schematic representation of an example system 50 that may be used to distinguish seeds containing an element or trait of interest from a bulk sample of seeds in accordance with one exemplary embodiment. In particular, the system 50 may be used to separate seed or grain based on optical differences in the starch composition. In some cases, the system may be a modified commercially available seed sorter. In the depicted embodiment, the seed sorter 50 includes at least one receptacle (e.g., seed hopper 52) for receiving a seed group comprising a plurality of seeds. The seed sorter 50 further includes at least one vision system 54 and at least one sorting device 55.

The example optical grain/seed sorter 50 has, for example, a grain/seed supply portion 52 that includes a storage tank and a vibratory feeder. Grains or seeds supplied from the supply portion flow continuously downward onto a slanted chute or channel aided by gravity (e.g., along arrow A). The seeds or grains can flow downward on the channel or through the chute and are capable of spreading laterally. In some embodiments, the seeds or grains may be allowed to flow through one or more parallel columns or channels. These multiple columnar paths or channels enable seed sorting at a high-speed and high-throughput manner. In some embodiments, the slanted chute may have a flat chute surface. The chute surface may have a plurality of flow-down grooves that have a width that is about the same as the width of each seed or grain. In such a manner, in some embodiments, the system 50 may be configured to sort seeds at a rate of approximately 200 seeds per channel per second.

In some embodiments, a bulk sample of seeds (e.g., a seed group), at least some of which may have been mixed with one or more seeds having an undesired trait, is loaded into a hopper 52. The hopper 52 is configured to funnel the seed group (e.g., through separate chutes or otherwise) for processing by the at least one vision system 54. In some cases, the seeds may be transported along arrow A (e.g., the seeds may fall by force of gravity) through the vision system 54.

In some embodiments, the vision system 54 may comprise: (1) an illuminating device 54a (such as a bulb, for example) that emits light at a particular wavelength and at a certain energy as described herein chosen to illuminate the seed sample, (2) an optional filter 54b that may be used to filter the energy emitted or the energy of the light transmitted through the seeds, and (3) an image sensing device 54c (e.g., a camera, a charge-coupled device, or any other image sensing device) for discerning seeds exhibiting a particular optical signature. In the depicted embodiment, the illuminating device 54a is located on the opposite side of the path of seeds as the image sensing device 54c and the optional filter 54b. In such a manner, the seeds are back-illuminated. The image sensing device 54c may aid in discerning optical characteristics displayed by amylopectin containing waxy kernels versus optical characteristics displayed by kernels from normal dent hybrids that contain a mixture of amylopectin and amylose.

In some embodiments, the at least one image sensing device 54c may be configured to differentiate between a range of optical differences between waxy (containing substantially amylopectin) and non-waxy (containing both amylopectin and amylose) maize kernels. For example, the image sensing device 54c may be configured to differentiate between level of opacity of each seed and, in some embodiments, determine if a level of opacity is above or below pre-determined level of opacity (e.g., such as to determine if the seed is waxy or non-waxy). As described herein, such an image sensing device 54c, in some cases, may include a component of a commercially available optical color sorter device. Furthermore, in some embodiments, the image sensing device 54c may include a charge-coupled device (“CCD device”) and/or a complementary metal-oxide-semiconductor device (“CMOS device”) configured for detecting differences of the transmitted light by waxy and non-waxy kernels. Although in some embodiments, the image sensing device may capture an image of each seed, in the depicted embodiment the image sensing device uses a single line scan CCD detector and individual pixels or groupings of adjacent pixels are analyzed.

In some embodiments, the at least one filter 54b may be disposed substantially between an image sensing device 54c (such as a CCD device) and the seeds containing a trait of interest. The filter 54b may be configured for passing the emission from the seed (e.g., the translucency of non-waxy kernels) to the image sensing device 54c. For example, in some embodiments, the filter 54b may comprise a band pass filter configured for passing light having a wavelength that is substantially equivalent to the targeted emission wavelength (i.e., the emission wavelength of energy emitted from an illuminated and/or excited seed containing a trait or a marker of interest). For example, the marker may be the type of starch present in a seed such as maize non-waxy kernels.

Optionally, in some embodiments, the filter 54b may enhance imaging sensitivity of the sensing device. For example, the filter 54b may enhance detection of optical differences exhibited by amylose and/or amylopectin in the non-waxy and waxy kernels, respectively.

In some embodiments, the image sensing device 54c (e.g., through an associated computing device) may assign substantially binary values to each seed based on the presence or absence of amylose. In such an embodiment, for example, seeds containing substantially amylopectin (as in the case of waxy maize kernels) may be marked “positive” (and thereby deflected and/or otherwise directed, such as by the sorting device 55, into one or more “+” containers 56). Seeds that contain a mixture of a substantial amount of amylose and amylopectin (which may be translated into a “negative” result) may be dropped and/or otherwise directed, such as by the sorting device 55, into one or more “−” containers 58.

As shown in FIG. 2, the image sensing device 54c (or other component of a vision system 54) may be in communication (such as through the control device 12) with a sorting device 55 (which may include, for example, a valve device and/or compressed air jet device) configured for directing the “positive” (i.e., seeds containing a trait of interest, such as “waxy” seeds) into one or more “+” containers 56. In some embodiments, the directing of such “positive” seeds may be in response to a binary positive or “1” signal received from the image sensing device 54c or other data processing component (e.g., control device 12). Likewise, the sorting device 55 may also be configured for directing the “negative” (i.e. seeds that do not contain a desired trait of interest or particulate debris, such as “non-waxy” seeds) into one or more “−” containers 58. In some embodiments, the directing of such “negative” seeds may be in response to a binary negative or “0” signal received from the image sensing device 54c or other data processing component (e.g., control device 12).

In the depicted embodiment, the image sensing device makes a binary decision on an individual pixel by pixel basis within the line scan. The user defines the minimum number of adjacent pixels along the line that are counted in order to consider the grouping to be a “defect.” Because of the properties of the non-waxy and waxy seeds, the system can be set up such that the waxy (opaque) seeds are essentially invisible to the detector. The light that passes through the non-waxy (translucent) seeds reaches the detector where illuminated pixels are then assigned into the “defect” class. The waxy seeds continue on their normal trajectory as defined by their exit from the chute. The non-waxy “defects” are displaced from the trajectory by the action of the ejectors. Thus, for a sample that contains more waxy seeds the ejectors are employed on the relatively infrequent non-waxy “defects,” rather than acting on the more frequent waxy seeds.

While the system 50 shown in FIG. 2 is shown oriented in a substantially vertical orientation (such that individual seeds may pass through the vision systems 54 in response to gravity forces), the system 50 may also be oriented in other fashions (e.g., substantially horizontally) and may comprise one or more pressurized pneumatic tubes and/or conveyance pathways configured for directing individual seeds through the various vision system components 54a, 54b, 54c and subsequently to a sorting device 55 that may be configured for transferring the seeds containing a trait or element of interest into corresponding “+” containers 56 and for transferring the seeds not containing the element or trait of interest into corresponding “−” containers 58 in response to signals received from one or more vision system 54 components and/or controllers.

In some embodiments, the illuminating device 54a may comprise a light source configured to emit light at a wavelength spectrum and/or intensity that illuminates maize kernels such that the translucency of amylose and amylopectin containing seeds (e.g., non-waxy seeds) are enhanced. Additionally or alternatively, in some embodiments, the light source may be any light source that permits the image sensing device 54c to discern the waxy vs. non-waxy maize kernels. In some embodiments, the system may include more than one image sensing device 54c and/or filters 54b such that illumination of waxy and non-waxy kernels is enhanced to aid in discerning the seed samples. As noted above, any vision system 54 configured to discern the presence of waxy vs. non-waxy maize kernels may be used, including, but not limited to, CCD devices, CMOS devices and other vision sensors.

In some embodiments, the sorting device 55 may include a number of individual pneumatic ejectors that emit a controlled blast of air (such as an “air knife” for example) to sort seeds that exhibit the desired trait as each seed passes through the sorting device 55. Seeds exhibiting the trait of interest (e.g., waxy kernels) may be projected into container 56, identified in the figure with a “+” symbol. Seeds that do not contain the trait of interest (e.g., non-waxy kernels) may be projected into container 58, identified in the figure with a “−” symbol.

Additionally, in some embodiments, the seeds contained in the “−” container 58 may be re-routed through the system, such as through hopper 52, so that these seeds make a successive pass through the system 50. In such a manner, any seeds that were not identified as having the trait of interest may be identified in one or more successive passes through the system 50. This successive passing through the system 50 may be referred to as two-pass, three-pass, four-pass, or a multi-pass sorting.

In some embodiments, the so-called “rejects” from the first pass may also be conveyed back through the system while the first pass is still being performed. Indeed, some seed sorters may have a plurality of channels such that concurrent pass-through is possible. Such multiple channel sorters may also be commercially available. In the depicted embodiment, however, the waxy (opaque) seeds may be rerouted through the system to ensure total removal of the non-waxy “defects.” As such, although there may be some loss of otherwise good waxy seeds in the discarded fraction, rerouting the waxy seeds may ensure optimal isolation of waxy seeds.

In some embodiments, a bulk sample of seeds (e.g., a seed group) may include various seeds having different types (e.g., starch types) and different amounts of a marker (e.g., content that may be associated with different desired traits). By singulating seeds from a bulk sample prior to evaluating the seeds for the presence or absence of a marker or a group of markers associated with a desired trait or group of traits, the methods disclosed herein may be used for evaluation of seeds not only for the presence or absence of a particular trait, but also for grading seeds based on the quality/quantity of the marker, such as amylopectin presence and quantity.

In some embodiments, such as the depicted embodiment of FIG. 2, the sorting system 50 may include a control device 12. The control device 12 may, in some embodiments, be configured to determine the translucency/transparency or opaqueness of each grain/seed based on an average intensity of the transmitted light through the seeds/grains. For example, in some embodiments, the cut-off ratio for sorting waxy and non-waxy seeds based on the presence of amylopectin and/or amylose (such as by the relative level of opacity) can be changed to accommodate a variety of seeds having different amounts of starch.

In some embodiments, when the control device 12 recognizes a non-waxy seed, for example, from the image processing signals from the image sensing device 54c (e.g., CCD) (or, in the depicted embodiment when the light that passes through the non-waxy (translucent) seeds reaches the detector and the illuminated pixels are assigned into the “defect” class), the control device 12 may generate a removal or sort signal and send the removal/sort signal to the sorting device 55 for an opening/closing valve in a removal/ejector device that includes air jet nozzles. In some embodiments, when the removal signal is received by the removal device, the removal device may briefly open the opening/closing valve to blow an air jet toward the seed fall-down path, thereby separating from the fall-down path the defective seed to be removed by generating the removal signal. As noted above, defective seeds/grains sorted out in this process may be separated from the seed sorter through a defective grain discharge port. Normal seeds that have passed through the fall-down paths without being acted on by the removal device may be recovered through a non-defective discharge port. In various embodiments, the sorter may be able to process approximately 200 seeds per channel per second.

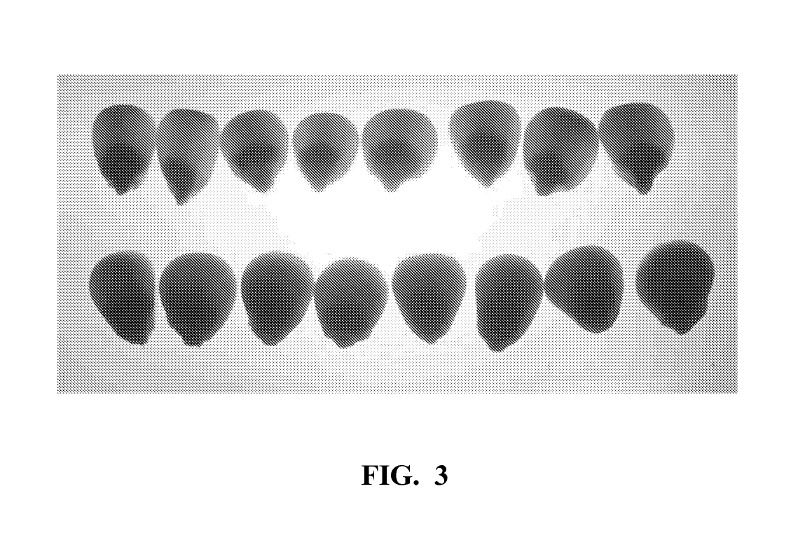

As noted above, in some embodiments, these seeds (such as, in the depicted embodiment, the waxy seeds) may optionally be transferred back to the hopper 52 for a second pass-through. For example, 2, 3, 4, 5, or 6 or more pass-throughs may be performed to improve the purity of sorted seeds to reduce contaminating seeds. Generally, 2 or 3 pass-throughs result in a sorting efficiency of greater than 95%, preferably 98% or 99%. Indeed, depending on the efficiency and accuracy of the sorter, seed purity of 90%, 91%, 92%, 93%, 94%, 95%, 96%, 97%, 99%, 99% and 100% is achieved with or without multiple pass-throughs. For example, FIG. 3 illustrates the sorted result of a seed group of waxy seeds (note all of the waxy seeds are not shown) and non-waxy seeds after one pass-through. In some embodiments the seeds may be subjected to one or more additional passes-through. FIG. 3 also illustrates the translucency of the non-waxy seeds and the opacity of the waxy seeds from being back-illuminated.

In some embodiments, the control device 12 may include a central processing unit (CPU). The central processing unit may include components essential for computing functions. This includes for example, an image memory, a translucency/transparency or opaqueness comparator, other comparators such as contour comparator, an image processing circuit, an analyzed image memory, an input/output circuit, a random-access memory (RAM) and a read-only memory (ROM). An operating panel and a sorting device may be connected as external devices to the input/output circuit. In embodiments where the sorting device includes air jet nozzles, the control device may include a valve opening/closing circuit for driving the air jet nozzles.

In some embodiments, the CPU may control the circuits and other components according to a predetermined program stored in the ROM or in a server located remotely. The image memory may take in the image signals from the CCD line sensors in accordance with a predetermined cycle time set in the control device. Image data in the image memory may then be updated by the first-in and first-out method.

In some embodiments, the translucency/transparency or opaqueness comparator may analyze images of grains by comparing image data generated from the image memory with a translucency/transparency or opaqueness threshold value for discrimination of the translucency/transparency or opaqueness of the seeds/grains, and then generate, for example, binary data representing the starch type of the seeds/grains. Images of the seeds may be formed in the image processing circuitry based in part on this data. In some embodiments, the contour images of seeds/grains may also be generated by the contour comparator in addition to the translucency/opaqueness thresholds.

In some embodiments, an example optical grain sorter is supplied with seeds/grains before sorting to the hopper. Images of seeds/grains falling along the slanting chute are taken at a suitable detection position in the fall-down paths by the CCD line sensors. The taken images are processed by the control device 12 as described above to be displayed on a monitor screen of a display device (not shown) in an operating panel. In some embodiments, an acceptable product (waxy) is a seed having a more opaque portion (amylopectin) than a seed/grain having a less opaque portion (defective-non-waxy).

In some embodiments, when an instruction is sent from the CPU to an operative nozzle indication circuit, the operative nozzle indication circuit may prepare data about the position of the air jet nozzle selected by the control means to be operated.

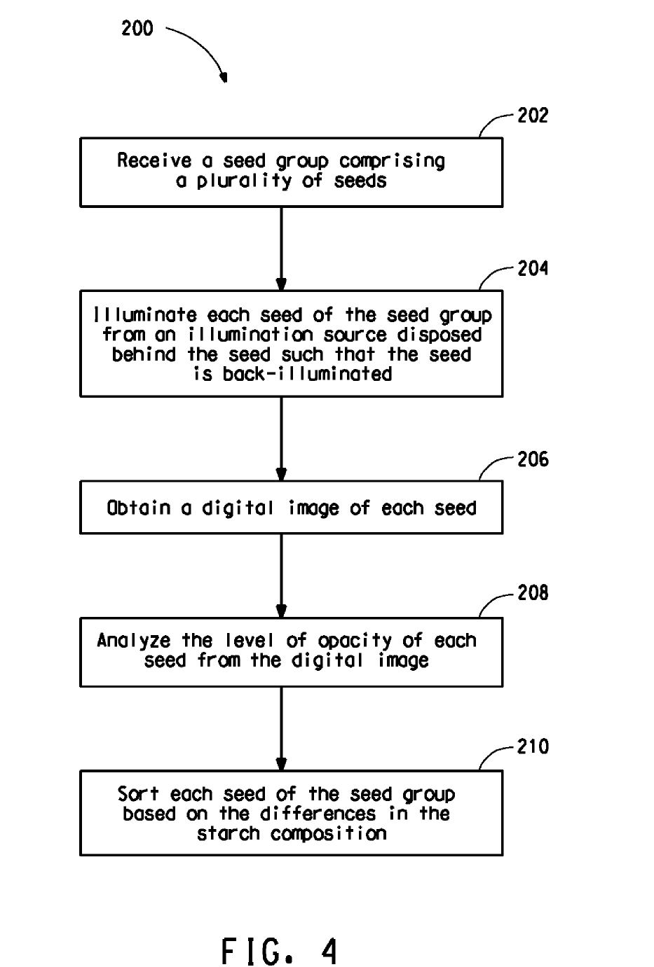

Embodiments of related methods are further provided herein. In this regard, FIG. 4 illustrates an embodiment of a method 200 for separating seed or grain based on optical differences in the starch composition. Embodiments of a method for separating seed or grain based on optical differences in the starch composition may be performed by various embodiments described herein, such as embodiments of the system 50 described above. As illustrated in the depicted embodiment of FIG. 4, the method 200 may comprise receiving a seed group comprising a plurality of seeds at operation 202. Further, the method may include illuminating each seed of the seed group from an illumination source disposed behind the seed such that the seed is back-illuminated at operation 204.

Additionally, in some embodiments, the method may include obtaining a digital image of each seed at operation 206. The method may also include analyzing the level of opacity of each seed from the digital image at operation 208.

Finally, the method may further include sorting each seed of the seed group based on the difference in the starch composition at operation 210.

Referring to Table 1 below, the results of an experiment are shown in which the methods and apparatuses of the present invention were used for separating seed or grain based on optical differences in the starch composition.

TABLE 1

| Batch | Initial | Final |
|---|---|---|
| ID # | Waxy % | Waxy % |
| 1 | 99.92 | 100 |
| 2 | 99.5 | 100 |
| 3 | 99.75 | 100 |
| 4 | 99.88 | 100 |
| 5 | 99.88 | 100 |
| 6 | 99.88 | 100 |
| 7 | 99.75 | 100 |
| 8 | 99.88 | 100 |
| 9 | 99.75 | 100 |
| 10 | 99.75 | 100 |
| 11 | 99.75 | 100 |
| 12 | 99.88 | 100 |
| 13 | 99.83 | 100 |
| 14 | 99.75 | 100 |
| 15 | 99.83 | 100 |
| 16 | 99.88 | 100 |
| 17 | 98.5 | 99.75 |
| 18 | 99.88 | 100 |
| 19 | 99.75 | 100 |

After an initial installation and configuration of an optical color seed sorter, a total of 19 separate waxy parent seed batches were processed through the sorter for failure to meet the 99.99% waxy purity standard. Each batch was subjected to three sequential passes through the sorter to affect complete removal of the non-waxy contaminants. Of the 19 batches, only one batch failed to meet the purity standard after sorting. Eighteen batches achieved 100% waxy purity as determined by standard laboratory assay techniques. The batch that did not meet specification requirements could have been subjected to additional passes through the sorter if indeed this particular inbred product was needed for meeting hybrid production requirements. Thus, the waxy sorting methodology prevented the discard of the majority of batches that would have otherwise not met the purity standards required for subsequent production of waxy hybrid products.

Many modifications and other embodiments of the disclosure will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for separating maize seeds based on optical differences in the starch composition, the method comprising:
receiving a seed group comprising a plurality of maize seeds;
illuminating each seed of the seed group from an illumination source disposed behind the seed such that the seed is back-illuminated; and
automatically sorting each seed of the seed group based on the differences in the starch composition.

2. The method of claim 1, wherein sorting each seed comprises determining whether or not each seed includes amylopectin content by determining a level of opacity of each seed.

3. The method of claim 1, wherein automatically sorting each seed of the seed group based on the differences in starch composition comprises sorting each seed of the seed group based on a level of opacity of the seed when illuminated.

4. The method of claim 1, wherein automatically sorting each seed of the seed group based on the differences in starch composition comprises sorting each seed of the seed group based on a level of translucency of the seed when illuminated.

5. The method of claim 1, wherein automatically sorting each seed comprises separating the seed group into the following groups: waxy seeds and non-waxy seeds.

6. The method of claim 1, wherein automatically sorting each seed comprises:
obtaining a digital image of each seed; and
analyzing a level of opacity of each seed from the digital image.

7. The method of claim 1, wherein automatically sorting each seed comprises:
sensing light from the illumination source that passes through at least some of the seeds; and
separating any such seed from seeds in which the light sensed is below a threshold value.

8. The method of claim 1, wherein automatically sorting each seed comprises separating each seed from the seed group that is determined to be below a pre-determined level of opacity.

9. The method of claim 1, wherein automatically sorting each seed comprises separating each seed into one of two containers.

10. The method of claim 1, wherein automatically sorting each seed from the seed group comprises sorting each with a sorting device that comprises at least one of: a valve device or a compressed air jet device.

11. The method of claim 1, wherein sorting each seed comprises sorting each seed from the seed group at a rate of approximately 200 seeds per channel per second.

12. The method of claim 1, wherein sorting each seed comprises determining whether or not each seed includes amylose by determining a level of translucency of each seed.

13. A method of reducing non-waxy contaminant seeds in a group of waxy and non-waxy maize seeds, the method comprising:
removing non-waxy maize seeds from the group such that the resulting purity of the waxy seeds is at least approximately 99.5%,
wherein said removing of the non-waxy seeds is performed by a high-throughput sorter such that approximately 200 seeds per channel per second are sorted.

14. The method of claim 13, wherein said removing non-waxy seeds from the group comprises sorting each seed of the seed group based on a level of opacity of the seed when illuminated.

15. The method of claim 13, wherein said removing non-waxy seeds from the group comprises sorting each seed of the seed group based on a level of translucency of the seed when illuminated.

16. The method of claim 13, wherein said removing non-waxy maize seeds comprises sending seeds through the sorter for one or more additional passes.

17. The method of claim 13, wherein the group of waxy and non-waxy maize seeds is selected from the group consisting of:
transgenic seeds;
non-transgenic seeds;
inbred seeds;
hybrid seeds; and
a mix of thereof.

18. The method of claim 13, wherein the resulting purity of the waxy seeds is approximately 99.95%.

19. A group of seeds that includes at least 99.5% waxy maize seeds, said group of seeds produced by a method comprising:
receiving a seed group comprising a plurality of waxy and non-waxy maize seeds;
illuminating each seed of the seed group from an illumination source disposed behind the seed such that the seed is back-illuminated; and
automatically sorting each seed of the seed group based on the differences in the starch composition.

20. The group of seeds of claim 19, wherein sorting each seed comprises determining whether or not each seed includes amylopectin content by determining a level of opacity of each seed.

21. The group of seeds of claim 19, wherein automatically sorting each seed of the seed group based on the differences in starch composition comprises sorting each seed of the seed group based on a level of opacity of the seed when illuminated.

22. The group of seeds of claim 19, wherein automatically sorting each seed of the seed group based on the differences in starch composition comprises sorting each seed of the seed group based on a level of translucency of the seed when illuminated.

23. The group of seeds of claim 19, wherein automatically sorting each seed comprises:
obtaining a digital image of each seed; and
analyzing a level of opacity of each seed from the digital image.

24. The group of seeds of claim 19, wherein automatically sorting each seed comprises:
sensing light from the illumination source that passes through at least some of the seeds; and
separating any such seed from seeds in which the light sensed is below a threshold value.

25. The group of seeds of claim 19, wherein automatically sorting each seed comprises separating each seed from the seed group that is determined to be below a pre-determined level of opacity.

26. The group of seeds of claim 19, wherein automatically sorting each seed comprises separating each seed into one of two containers.

27. The group of seeds of claim 19, wherein automatically sorting each seed from the seed group comprises sorting each with a sorting device that comprises at least one of a valve device or a compressed air jet device.

28. The group of seeds of claim 19, wherein sorting each seed comprises sorting each seed from the seed group at a rate of approximately 200 seeds per channel per second.

29. The group of seeds of claim 19, wherein sorting each seed comprises determining whether or not each seed includes amylopectin content by determining a level of translucency of each seed.

30. The group of seeds of claim 19, wherein the group of seeds includes 99.95% waxy maize seeds.

31. The method of claim 1, wherein sorting each seed comprises determining whether or not each seed includes amylose content by determining a level of opacity of each seed.

32. The method of claim 1, wherein sorting each seed comprises determining whether or not each seed includes amylopectin content by determining a level of translucency of each seed.

33. The group of seeds of claim 19, wherein sorting each seed comprises determining whether or not each seed includes amylose content by determining a level of opacity of each seed.

34. The group of seeds of claim 19, wherein sorting each seed comprises determining whether or not each seed includes amylose content by determining a level of translucency of each seed.
